(19) United States
(12) Patent Application Publication
(10) Pub. No.: US 2008/0229430 A1
(43) Pub. Date: Sep. 18, 2008

(54) METHOD FOR PREVENTING PRANK ORDERS FOR INTERNET PURCHASING

(76) Inventor: James B. Kargman, Chicago, IL (US)

Correspondence Address: SCHIFF HARDIN, LLP;PATENT DEPARTMENT, 6600 SEARS TOWER, CHICAGO, IL, 60606-6473, US

(21) Appl. No.: 12/048,566

(22) Filed: Mar. 14, 2008

Related U.S. Application Data
(60) Provisional application No. 60/894,921, filed on Mar. 15, 2007.

(51) Int. Cl. G06F 21/00

(52) U.S. Cl. 726/28

(57) ABSTRACT

A system and method are provided for establishing a secure user account, comprising contacting a registration server by a user and then providing, by the user, identification information of the user that identifies a verifiable hardware user device having third-party verifiable account information associated with it. The registration server sends, to the user, a verification contact address. The user then contacts the verification server, which may be the registration server, at the verification contact address using the verifiable hardware user device. The verification server then obtains the third-party verifiable account information from a third party associated with the verifiable hardware user device. Finally, the verification server authorizes the secure user account if the third-party verifiable account information matches, in part, the identification information provided by the user.

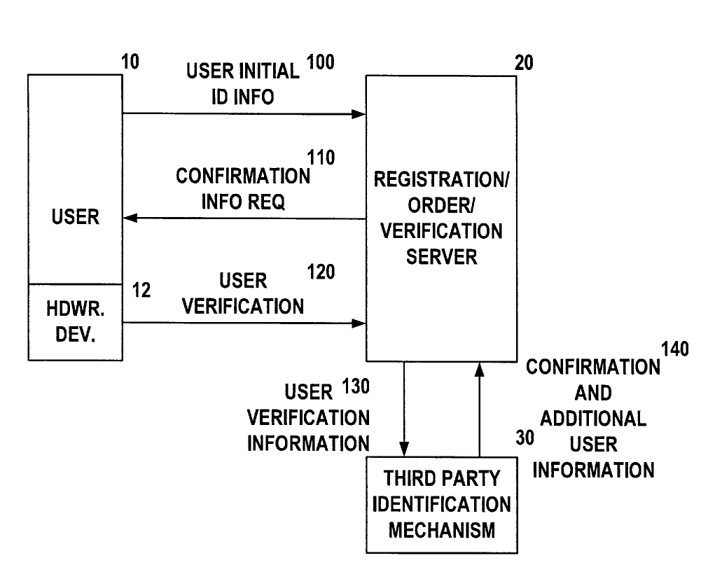

### CROSS REFERENCE TO RELATED APPLICATIONS

The present application claims the benefit of U.S. Provisional Application No. 60/894,921, filed Mar. 15, 2007.

### BACKGROUND

The Internet has greatly increased the ease with which customers may order products. However, this ease of ordering also opens the door to potential abuses. One such abuse is that pranksters can make orders for products while pretending that they are someone else. This creates substantial problems and expenses for the vendor who attempts to make good on such an order, particularly where the ordered goods are perishable, such as in the food industry.

While devices connected to the Internet must have an “IP” address consisting of 4 (IPV4) or 6 (IPV6) octets of information such as 101.23.43.55, these numbers may or may not constitute a positive identifier. There are two types of IP addresses, static and dynamic. A static IP address always presents the same octets for every connection, a dynamic IP address can change at any time, even during idle periods in a connection. The nature of the Internet, however, makes it possible for people with static IP addresses to connect through “proxy” addresses so as to hide their actual IP address. For this reason additional verification steps are necessary to establish customer identities to prevent and deter fraud.

It is known in the industry to permit first-time users to set up accounts on-line in a registration process. In such systems, the user is asked to choose a username and password, and then enter additional relevant information, such as address, telephone number, credit card number, etc. This entered information is then stored in a database on (or accessible by) the order server. Once the user has successfully registered, any time he logs on after this, the server associates the user data with the individual logging in.

It is also known in the industry to validate a user as follows. Once the user has completed a registration process, which includes the entry of an e-mail address, the server maintains the account in a state indicating that a further verification or authentication step needs to take place before the user can log in. This is often done by the server sending an e-mail to the provided address that contains an activation code to be used. The user simply has to read the message and click on a hyperlink in order to fully register. The hyperlink usually contains a special code embedded in it that serves as the verification to the server.

This scheme works fine in a situation in which a service provider simply needs to authenticate that a particular e-mail address is associated with the user. However, such a scheme does not serve to prevent abuse of an order system by pranksters in, e.g., the fast food industry, because many services offer free e-mail accounts that do not require positive identification of the e-mail account holder. Since they are cost free and essentially untraceable, multiple e-mail addresses such as this can be utilized by a prankster. Therefore a more robust mechanism is needed.

### SUMMARY

The invention relates to a system and appertaining method for establishing a secure user account, comprising: contacting a registration server by a user; providing, by the user, identification information of the user that identifies a verifiable hardware user device having third-party verifiable account information associated with it; sending, by the registration server to the user, a verification contact address; contacting, by the user, a verification server, which may be the registration server, at the verification contact address using the verifiable hardware user device; obtaining, by the verification server, the third-party verifiable account information from a third party associated with the verifiable hardware user device; and authorizing the secure user account if the third-party verifiable account information matches, in part, the identification information provided by the user.

### DESCRIPTION OF THE DRAWINGS

The invention is described in more detail according to various preferred embodiments below with reference to the FIGURE, which is a block diagram, and the associated description.

### DETAILED DESCRIPTION OF THE PREFERRED EMBODIMENTS

The FIGURE illustrates an embodiment of the invention, in which a secure user account is established with the aid of a third-party identification mechanism.

According to one envisioned embodiment, the user 10 registering on a registration or order server 20, e.g., a pizza web site, includes initial user identification information 100, such as her phone number along with the other possible registration information.

The registration server 20 receives the initial user identification information 100 and creates a preliminary user account that is subject to verification, which completes an initial portion of the registration process. The user is then asked to complete the final step(s) of the registration process by being given information related to a required confirmation 110 of the user. This confirmation information 110 includes some form of address (used in a general sense) that the user 10 uses contact the verification server 20 in order to complete the verification. This could include a telephone number, web address, etc., and can possibly include an SMS short code, and potentially an optional code (numeric or alphanumeric) with instructions to, e.g., call the telephone number. As noted previously, the registration/order server 20 could be the same system as the verification server 20, or they could be separate systems.

The user 10 then contacts the verification server 20 at the verification contact address provided using a verifiable hardware device 12 for user verification 120, and provides any additional information requested by the verification server 20. The verification server 20 then utilizes a third-party identification mechanism 30, and, using the user verification information 130, obtains confirmation (or rejection) 140 of the user's identity along with additional user information that can include account information. Once this confirmation 140 has been completed, the secure user account is established for the particular hardware device 12, and the user can then interact with the order server 20 for goods and services, and the merchant can safely presume that the user 10 placing the order is authentic.

In one embodiment, the verifiable hardware device 12 is a telephone. The telephone network provides two methods of caller identification as the third-party identification mechanism 30: CLID (Calling Line Identification or “Caller ID”), and ANI (“Automatic Number Identification). When the user 10 calls in with a code, the user 10 can be identified by using either CLID or ANI. Other or further forms of verification can ensue through the use of the optional codes discussed previously. CLID is an analog signal that is passed between the first and second rings of a telephone and can be detected by a caller ID detector. CLID signaling includes the line location address of the telephone terminal, which often provides more specific location information than ANI, which reports the billing telephone number that is responsible for the billing for a line. It should be noted that the CLID digits can be injected into the telephone system from the originating telephone number using call processing equipment, so it should be noted that it can be “spoofed”, but this requires specialized equipment and systems. ANI is a digital signal that is sent on the signaling channel of a digital telephone circuit, and since it includes the billing address, this may or may not correspond to the actual location of the telephone, but it does serve as a third-party verified authentication and verification. ANI information is translated into a CLID signal for presentation on analog CLID receivers.

In addition to the landline telephone network, other mechanisms may be used for interrogation as the third-party identification mechanism 30, such as a cable network terminal identifier such as provided by set-top boxes, or satellite station identifier, and for pipeline and power line connections the service point identifier associated with a remote billing transmitter. Various mechanisms are available to positively identify a service location, such as the meter number, or account code, and these values are accessible in some cases visually, and also electronically.

Although it was noted previously that with dynamic IP addresses, the IP address itself would not sufficiently serve to identify an Internet-connected user computer as the verifiable hardware device 12, with suitable interrogation and response mechanisms integrated with the Internet connection and combined with a secure encryption mechanism.

For example, for digital rights management, devices such as Apple's iPod, iPhone, Microsoft's Zune and Google's Android platform, provide application development kits that include high level encryption functions such as AES 128 Cipher Block Chain, and the ability to send and receive in SSL (Secure Sockets Layer) or the new TLS encrypted transmissions standards. The programmable features of these devices, combined with the ability to read a device serial number, or in the case of a cell phone device the device serial number or it's unique electronic signature (SSID), which is used for billing purposes, can provide a reasonable degree of confidence that if an encoded transmission is received from such a device, the data being exchanged can be verified as to source device. In addition to the hardware recognition capabilities, the use of the encoded messages could also be combined with a personal pin number, or a digital certificate provided by a certificate authority, further increasing the ability to tie a message to both a device, and a 3^{rd} party certificate signing authority verifying a particular identity, especially if this is combined with a PIN code for additional authentication. Putting a time limit on a particular query can help reduce the possibility of spoofing. The use of a digital certificate combined with a PIN code can defeat cloning of a specific device. This would work unless the PIN code itself is compromised. The use of digital certificates can be implemented as a way of assuring that an e-mail communication is from a known person.

These networks can also provide a positive correlation between Internet identities and verifiable real-world identities. In short, any attribute of the hardware or software that can serve to identify the point of origin and individual associated with an order can take advantage of this system and method.

While the primary benefit of connecting the user's online account information with the e.g., real-world telephone (landline or cell phone) network information is to reduce fraud and prank orders, this mechanism also enhances the data available to the registration/order server 20 by connecting real world customer attributes to online behavior characteristics. Thus, in addition to reducing the potential for fraud, the enhanced customer attribute information provides valuable marketing information. Connecting, e.g., a website associated with the registration/order server 20 to either the cell phone network or the landline telephone network (or other verifiable device mechanism) provides a double check on the identity of the consumer, by using a third-party identification mechanism 30 that also happens to enjoy legal protection from abuse along with positive built-in line or device identification. This is advantageous because determining the identity of a prankster or fraudulent user from a telephone number or other attribute associated with a physical device of the user is much easier and more reliable to do than if this were done using the e-mail for confirmation. It is difficult, if not impossible, to convey a false phone number, calling line identification, hardware address (such as a network card MAC address, etc.) in such a system. This system could be utilized for both a land line, cell phone, networked computer, etc.

A similar scheme could be utilized in an SMS context. In this scheme, the user 10 is given a special code and a place to text message a response with the code to when the registration server 20 sends the confirmation information request 110 to the user 10. Upon receipt of the SMS message as the user verification 120 from the registrant, the server 20 records and check the appertaining device ID or phone number, combined with the generated identification code as the third-party identification mechanism. Combining the web information with the positive telephony (or other hardware device) identification information, and the optional transaction specific identification information can serve to provide specific and valuable customer demographic information as well, which can help marketers and advertisers to more effectively serve their market.

A more sophisticated version could be implemented using an IP address, although, as noted above, the method would have to ensure that a proxy IP address is not being improperly utilized for false identification purposes. To accomplish this you would have to use Public Private Key exchange, since a proxy device cannot be detected from a local device. It may also be possible to utilize, e.g., the MAC address of the user's hardware for this purpose, although the MAC address can be “spoofed” or impersonated, just as are IP addresses, but the public private key exchange cannot be compromised.

The system or systems may be implemented on any general purpose computer or computers and the components may be implemented as dedicated applications or in client-server architectures, including a web-based architecture. Any of the computers may comprise a processor, a memory for storing program data and executing it, a permanent storage such as a disk drive, a communications port for handling communications with external devices, and user interface devices, including a display, keyboard, mouse, etc. When software modules are involved, these software modules may be stored as program instructions executable on the processor on media such as tape, CD-ROM, etc., where this media can be read by the computer, stored in the memory, and executed by the processor.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The word mechanism is used broadly and is not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various FIGURES presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A method for establishing a secure user account, comprising:
contacting a registration server by a user;
providing, by the user, identification information of the user that identifies a verifiable hardware user device having third-party verifiable account information associated with it;
sending, by the registration server to the user, a verification contact address;
contacting, by the user, a verification server, which may be the registration server, at the verification contact address using the verifiable hardware user device;
obtaining, by the verification server, the third-party verifiable account information from a third party associated with the verifiable hardware user device; and
authorizing the secure user account if the third-party verifiable account information matches, in part, the identification information provided by the user.

2. The method according to claim 1, wherein the verifiable hardware user device is a telephone, and the third party verifiable account information is obtained using at least one of CLID and ANI.

3. The method according to claim 2, wherein the user device is a cellular telephone.

4. The method according to claim 1, wherein the verifiable user device is an SMS text messaging device, the method further comprising:
sending, by the registration server to the user, a verification code along with the verification contact address; and
transmitting the verification code to the verification server.

5. The method according to claim 1, wherein the verifiable hardware user device is a computing device (including wireless phone, computer, PDA or other computer device, and the third-party identification mechanism utilizes at least one of: a) information about a fixed hardware address of the user; and b) a wired or wireless network terminal identifier.

6. The method according to claim 1, further comprising obtaining, by the registration server, user behavior characteristics for marketing purposes.

7. A system for establishing a secure user account, comprising:
a registration server that is contacted by a user;
a verifiable hardware user device having third-party verifiable account information associated with it;
an input of the registration server via which the user provides identification information of the user that identifies the verifiable hardware user device;
a verification server, which may be the registration server, having a verification contact address that is sent by the registration server to the user and contacted by the user via the verification contact address;
